(19) United States
(12) Patent Application Publication
(10) Pub. No.: US 2023/0328161 A1
(43) Pub. Date: Oct. 12, 2023

(54) MOBILE DEVICE SCREEN EXTENSION ASSEMBLY

(71) Applicant: Delmar Edward Armstrong, Moreno Valley, CA (US)

(72) Inventor: Delmar Edward Armstrong, Moreno Valley, CA (US)

(21) Appl. No.: 17/714,746

(22) Filed: Apr. 6, 2022

(51) Int. Cl. H04M 1/02; G06F 1/16

(52) U.S. Cl. CPC H04M 1/0266; G06F 1/1624; G06F 1/1649; G06F 1/1643

(57) ABSTRACT

A mobile device screen extension assembly for extending the screen of a touch screen mobile device includes a mobile device is a known product such as a Smartphone. The mobile device has a peripheral surface and a bottom surface. The mobile device has a first side edge and a second side edge. Furthermore, the mobile device has a first screen. Additionally, the mobile device has an interior. The first side edge has an opening providing access to the interior. A second screen nests within the interior of the mobile device and can be positioned adjacent to the mobile device. The second screen has a retractable edge. The retractable edge of the second screen withdraws the second screen from the opening of the interior of the mobile device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to extended mobile devices and more particularly pertains to a new extended mobile device for extending the screen of a touch screen mobile device.

### (2) Description of Related Art Including Information Disclosed Under 37 CFR 1.97 and 1.98

The prior art relates to extended mobile devices. The prior art relates to a variety of extended mobile devices configured for extending the screen or the keyboard. Known prior art lacks an extended mobile device configured for withdrawing a second screen positioned within an interior of the mobile device.

### BRIEF SUMMARY OF THE INVENTION

An embodiment of the disclosure meets the needs presented above by generally comprising a mobile device is configured for is a known product such as a Smartphone. The mobile device has a peripheral surface and a bottom surface. The mobile device has a first side edge and a second side edge. Furthermore, the mobile device has a first screen. In addition, the mobile device has an interior. The first side edge has an opening being configured for providing access to the interior. A second screen is configured for nesting within the interior of the mobile device and being positioned adjacent to the mobile device. The second screen has a retractable edge. The retractable edge of the second screen is configured for withdrawing the second screen from the opening of the interior of the mobile device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a mobile device screen extension assembly according to an embodiment of the disclosure.

FIG. 2 is a front view of an embodiment of the disclosure.

FIG. 3 is a back view of an embodiment of the disclosure.

FIG. 4 is a bottom view of an embodiment of the disclosure.

FIG. 5 is a side view of an embodiment of the disclosure.

### DETAILED DESCRIPTION OF THE INVENTION

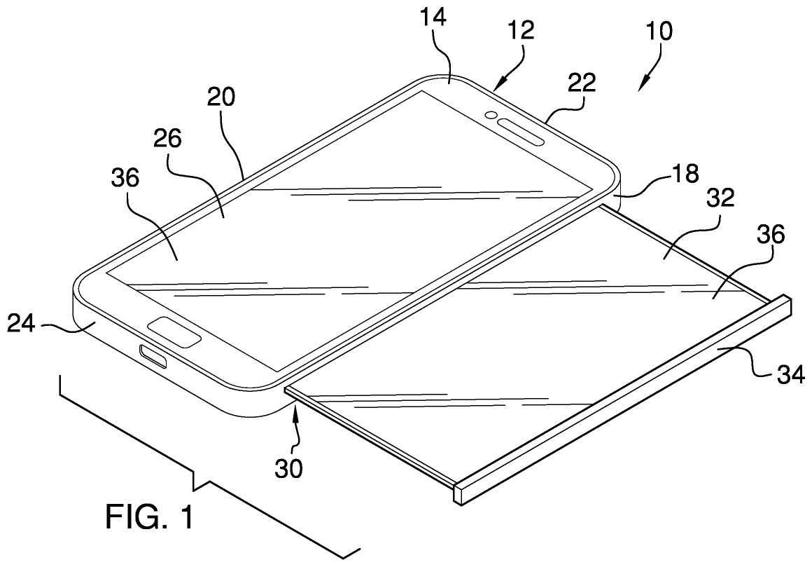

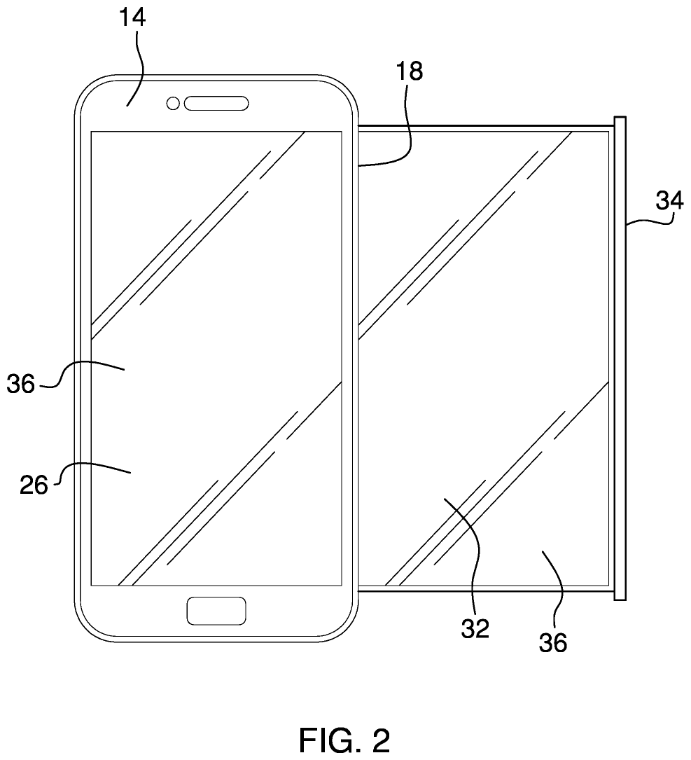

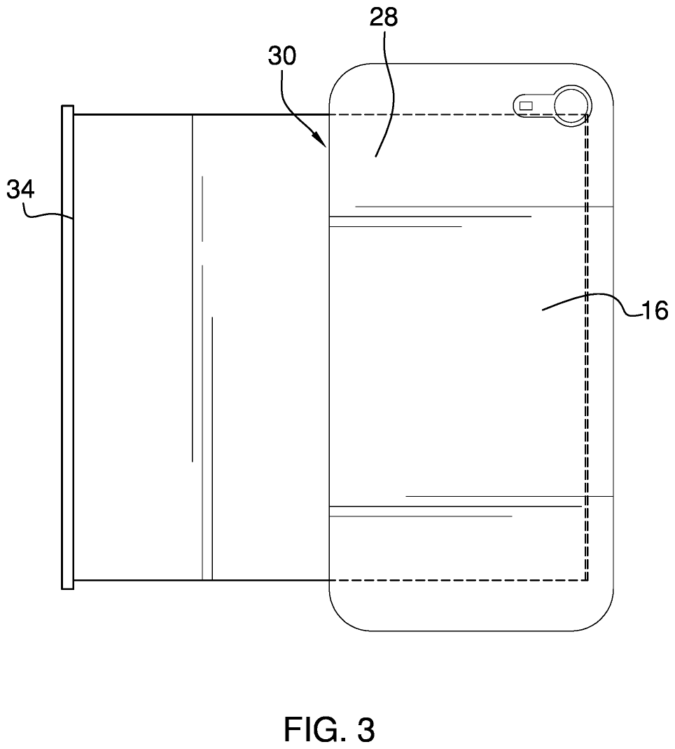

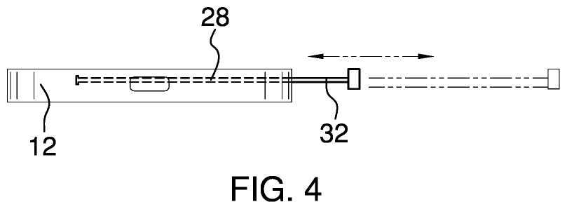

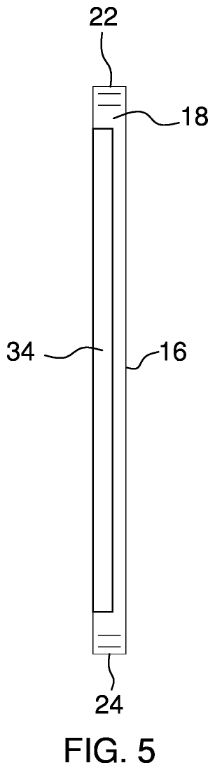

With reference now to the drawings, and in particular to FIGS. 1 through 5 thereof, a new extended mobile device embodying the principles and concepts of an embodiment of the disclosure and generally designated by the reference numeral 10 will be described.

As best illustrated in FIGS. 1 through 5, the mobile device screen extension assembly 10 generally comprises a mobile device 12 configured for being a known product such as a Smartphone. The mobile device 12 has a rectangular prism shape. Furthermore, the mobile device 12 has a peripheral surface 14 and a bottom surface 16 being positioned parallel to each other. A first side edge 18 and a second side edge 20 of the mobile device 12 are positioned perpendicular to a first lateral edge 22 and a second lateral edge 24. The peripheral surface 14 and the bottom 16 surface are positioned perpendicular relative to the first side edge 18 and the second side edge 20.

A first screen 26 is positioned on the peripheral surface 14 of the mobile device 12. The first screen 26 is configured for having touch screen capabilities 34, wherein the user can engage with the mobile device 12 by touching the first screen 26 with a finger of the user. In addition, the mobile device 12 has an interior 28. The interior 28 defines a space for a variety of elements to be positioned within. The first side edge 18 of the mobile device 12 has an opening 30. The opening 30 is configured for providing access to the interior 28 of the mobile device 12.

A second screen 32 is configured for nesting within the interior 28 of the mobile device 12 and being positioned adjacent to the mobile device 12. The second screen 30 has a retractable edge 34 being positioned adjacent to the first side edge 18 of the mobile device 12. The retractable edge 34 of the second screen 32 is configured for withdrawing the second screen 30 from the interior 28 of the mobile device 12. The second screen 32 is configured for being in communication with the first screen 26, wherein the second screen 32 will obtain touch screen capabilities 36 when positioned adjacent to the mobile device 12.

In use, the second screen 32 is nested within the interior 28 of the mobile device 12, wherein the first screen 26 is used to engage the user with the mobile device 12. The retractable edge 34 of the second screen 34 can be pulled away from the first side edge 18 of the mobile device 12 to display the second screen 32. When the second screen 32 is positioned adjacent to the mobile device 12, the second screen 32 can be used to engage the user with the mobile device 12 in addition to the first screen 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mobile device screen extension assembly being configured for retracting a second screen from an interior of the mobile device, the assembly comprising:
a mobile device being configured for being a known product such as a Smartphone, the mobile device having a peripheral surface and a bottom surface, the mobile device having a first side edge and a second side edge, the mobile device having a first screen, the mobile device having an interior, the first side edge having an opening, the opening being configured for providing access to the interior; and
a second screen being configured for nesting within the interior of the mobile device and being positioned adjacent to the mobile device, the second screen having a retractable edge, the retractable edge of the second screen being configured for withdrawing the second screen from the opening of the interior of the mobile device.

2. The mobile device screen extension assembly of claim 1, further comprising the mobile device having a rectangular prism shape.

3. The mobile device screen extension assembly of claim 1, further comprising the mobile device has a first lateral edge and a second lateral edge.

4. The mobile device screen extension assembly of claim 3, further comprising the first lateral edge and the second lateral edge being positioned perpendicular relative to the first side edge and the second side edge.

5. The mobile device screen extension assembly of claim 1, further comprising the first screen being positioned on the peripheral surface of the mobile device.

6. The mobile device screen extension assembly of claim 1, further comprising the first screen being configured for having touch screen capabilities.

7. The mobile device screen extension assembly of claim 1, further comprising the interior defining a space for a variety of elements to be positioned within.

8. The mobile device screen extension assembly of claim 1, further comprising the retractable edge of the second screen being positioned adjacent to the first side edge of the mobile device.

9. The mobile device screen extension assembly of claim 1, further comprising the second screen being configured for being in communication with the first screen.

10. A mobile device screen extension assembly being configured for retracting a second screen from an interior of the mobile device, the assembly comprising:
a mobile device being configured for being a known product such as a Smartphone, the mobile device having a rectangular prism shape, the mobile device having a peripheral surface and a bottom surface, the mobile device having a first side edge and a second side edge, the mobile device has a first lateral edge and a second lateral edge, the first lateral edge and the second lateral edge being positioned perpendicular relative to the first side edge and the second side edge, the mobile device having a first screen, the first screen being positioned on the peripheral surface of the mobile device, the first screen being configured for having touch screen capabilities, the mobile device having an interior, the interior defining a space for a variety of elements to be positioned within, the first side edge having an opening, the opening being configured for providing access to the interior; and
a second screen being configured for nesting within the interior of the mobile device and being positioned adjacent to the mobile device, the second screen having a retractable edge, the retractable edge of the second screen being positioned adjacent to the first side edge of the mobile device, the retractable edge of the second screen being configured for withdrawing the second screen from the opening of the interior of the mobile device, the second screen being configured for being in communication with the first screen.
